(19) United States
(12) Patent Application Publication
(10) Pub. No.: US 2010/0254443 A1
(43) Pub. Date: Oct. 7, 2010

(54) DIGITALLY CONTROLLED ISOLATED POWER CONVERTER

(76) Inventors: Martin Josef Scharrer, Straubing (DE); Mark Keith Halton, County Limerick (IE); Anthony Gerard Scanlan, County Limerick (IE)

Correspondence Address: JACOBSON HOLMAN PLLC, 400 SEVENTH STREET N.W., SUITE 600, WASHINGTON, DC, 20004, US

(21) Appl. No.: 12/734,749

(22) PCT Filed: Nov. 20, 2008
(86) PCT No.: PCT/IE2008/000110

§ 371 Date: May 20, 2010

Related U.S. Application Data
(60) Provisional application No. 60/996,490, filed on Nov. 20, 2007.

(51) Int. Cl. H04B 1/38; H04B 3/00

(52) U.S. Cl. 375/220; 375/258

(57) ABSTRACT

A digital SMPC (1) comprises an SMPS Transformer primary side (2) and an SMPS secondary side (3). Opto-couplers (4) perform bi-directional communication between primary side and secondary side communication circuits (5, 6). The primary side communication circuits (5) are connected via a loop controller (7) to the primary side (2). The secondary side communication circuits 6 are connected to the secondary side 3 via an ADC (8). The analogue-to-digital converter (ADC, 8) digitises the output voltage V0 on the secondary side. The secondary side communication module (6) encodes this value and uses the data couplers (4) to transmit it over the isolation barrier. The primary side communication module (5) receives and decodes the value and provides it to the loop controller module (7). The loop controller (7) is implemented as a Digital Signal Processor (DSP) or a hardware PID-controller. A Digital Pulse Width Modulator (DPWM) generates the switching signals for the primary side power stage (2), which stabilizes the secondary side output voltage Vₒ.

### FIELD OF THE INVENTION

The invention relates to control of power converters.

### PRIOR ART DISCUSSION

In an isolated switched mode power converter there is no electrical connection between the primary and secondary side. The traditional analog control of SMPCs is shown in FIG. 1. The primary side high voltage DC or AC is converted to a low voltage DC signal across a transformer. The DC signal is compared with a reference level and an error signal Vₒ generated. This error signal is transmitted to the primary side through an optocoupler. The pulse width modulator (PWM) acts on this error signal generating signals that control switches on the primary side thereby regulating the secondary side voltage.

The traditional analog scheme supports the design of precise and inexpensive isolated SMPCs, and is therefore highly popular. However, despite its popularity it is recognised that it suffers from a number of serious drawbacks including the following:
The LED of the optocoupler suffers from a significant reduction of light emission over the life of the optocoupler, this being particularly accelerated at high operating temperatures.
Incompatibility with emerging digital SMPC control.
High component count leading to reliability penalties, increased manufacturing cost, and material management challenges.
Fixed output voltage (i.e. non-programmable), set through resistor network and voltage reference.
Fixed frequency compensation, and closed-loop performance (set through passive networks), unsuitable for advanced, adaptive digital control.
Undesirable zero in compensator gain through parasitic modulation of optocoupler LED current.
Messy converter startup due to U2 behaviour (integrator wind-up) leading to non-monotonic Vo rise.
Inability to detect open-loop condition (missing or mal-functioning component in feedback path).

Prodić A., Erickson R. W. and Maksimović D., “Digital Controller Chip Set For Isolated DC-DC Power Supplies”, IEEE APEC 2003, February 2003, pp. 866-872, describes an arrangement in which a clock signal is fed forward to the secondary side on an extra line.

WO2003/049267 describes capacitive coupling for communication between primary and secondary sides of a power converter.

The invention is directed towards providing improved digital power converter control.

### SUMMARY OF THE INVENTION

According to the invention, there is provided a digital power converter having primary and secondary power stages, primary side circuits including a loop controller, secondary side circuits including an ADC, a communications interface between the primary and secondary sides, wherein each of the primary and secondary side circuits include a transmitter and a receiver for bi-directional communication of data across the interface.

In one embodiment, the secondary side circuits comprise means for using encoded data from the primary side to adjust a reference voltage.

In one embodiment, the circuits of both sides comprise means for sending auxiliary data to the other side, including over-voltage protection safety signals.

In one embodiment, the auxiliary signals include over-temperature protection signals.

In one embodiment, the auxiliary signals include power failure signals.

In one embodiment, the auxiliary signals include user data.

In one embodiment, the transmitters and receivers register incoming and outgoing signals, and synchronise incoming asynchronous signals.

In one embodiment, the transmitters and receivers ensure correct i/o timing such as reading an ADC result back.

In one embodiment, at least one transmitter comprises a shift register for data transfer across the interface.

In one embodiment, the transmitter and receiver are combined as a transceiver on at least one side.

In one embodiment, the primary side loop controller is adapted to adjust the sample time instant of the secondary side ADC.

In one embodiment, the secondary side circuits are adapted to receive an encoded data packet and use it as an ADC sample trigger.

In one embodiment, the interface comprises two couplers for bi-directional communication

In one embodiment, the interface comprises at least one opto-coupler.

In one embodiment, the primary side circuits are adapted to generate data packages and to send them, across the interface to the secondary side circuits.

In one embodiment, said packages generated by the primary side circuits include a digital representation of a nominal output voltage.

In one embodiment, said packages generated by the primary side circuits include a package number for synchronisation of packages on both sides.

In one embodiment, said primary side circuits are adapted to transmit to the secondary side circuits packages containing a package number and successive packages for a frame have a number which is incremented, and the secondary side circuits are adapted to synchronise to the package numbers to ensure the correct order and alignment of information bits, and the secondary side circuits are adapted to transmit to the primary side circuits packages which are direct responses to received packages.

In one embodiment, said packages generated by the secondary side circuits include an ADC value indicating output voltage and auxiliary data signals.

In one embodiment, the secondary side circuits comprise a clock synchronizer for extracting the primary side clock from a data stream and outputting both a recovered clock and synchronized data and for using a falling edge of the recovered clock is to send secondary side data back to the primary side and the primary side circuits are adapted to read an incoming data stream without the need of further synchronization because the clock is held synchronous to the primary side clock.

In one embodiment, the secondary side circuits are adapted to transmit data packages to the primary side circuits in synchronism with said clock.

In one embodiment, said clock synchronizer comprises a master clock which operates at a multiple N of a nominal primary side clock, and a state machine which has a number 2N+2 of intermediate states and 2 start-up states; wherein each state is represented by a received serial data bit and a bit which is the secondary side master clock; and the state machine moves between states directed by a change in either of said bits and while the state machine remains in states 0−N the recovered clock is nominally zero, and while the machine is in states N−2N−1 the state is 1.

In one embodiment, the loop controller comprises a digital pulse width modulator adapted to provide a signal that controls the primary side switches, in which rising and falling edges of this signal cause the switches to turn ON/OFF, causing a transient disturbance on the secondary side output; and the loop controller is adapted to transmit a signal to the ADC to cause the sampling instant to occur midway between the rise and fall of the DPWM signal, to allow optimal positioning of the ADC sampling instant.

In one embodiment, the loop controller is adapted to compensate for latency in communication between the primary side circuits and the secondary side circuits by advancing timing of a data packet transmission.

### DETAILED DESCRIPTION OF THE INVENTION

### BRIEF DESCRIPTION OF THE DRAWINGS

The invention will be more clearly understood from the following description of some embodiments thereof, given by way of example only with reference to the accompanying drawings in which:

FIG. 1 is a diagram illustrating a prior art analogue control isolated SMPC;

FIG. 2 is a block diagram of a digital SMPC of the invention, incorporating an opto-coupler for bi-directional communication between primary and secondary sides;

FIG. 3 is a block diagram showing bi-directional communication blocks of the SMPC;

FIG. 4 shows a primary side transceiver in more detail, and FIG. 5 shows a secondary side transceiver in more detail;

FIG. 6 shows control of ADC sampling; and

FIG. 7 is a diagram illustrating a mechanism for clock synchronisation across the opto-coupler.

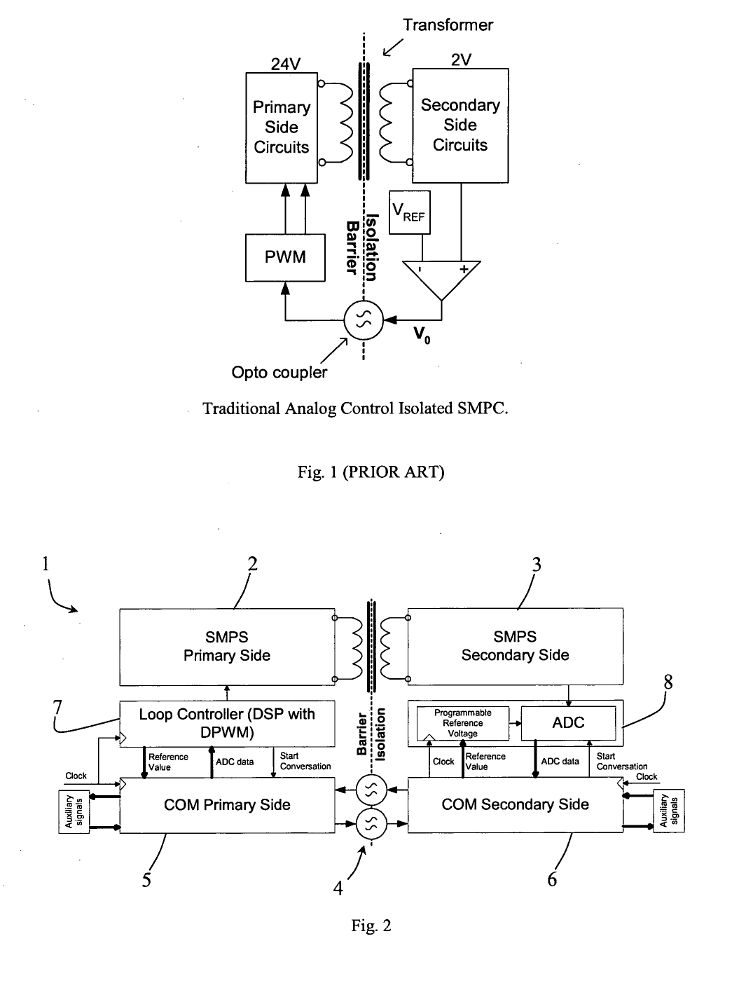

### DESCRIPTION OF THE EMBODIMENTS

Referring to FIG. 2 a digital SMPC 1 comprises an SMPS primary side 2 and an SMPS secondary side 3. Opto-couplers 4 perform bi-directional communication between primary side and secondary side communication circuits 5 and 6. The primary side communication circuits 5 are connected via a loop controller 7 to the primary side 2. The secondary side communication circuits 6 are connected to the secondary side 3 via an ADC 8.

The analogue-to-digital converter (ADC) 8 digitises the output voltage Vₒ on the secondary side. The secondary side communication module 6 encodes this value and uses the data couplers 4 to transmit it over the isolation barrier. The primary side communication module 5 receives and decodes the value and provides it to the loop controller module 7. The loop controller 7 is implemented as a Digital Signal Processor (DSP) or a hardware PID-controller. A Digital Pulse Width Modulator (DPWM) generates the switching signals for the primary side power stage 2, which stabilizes the secondary side output voltage Vₒ.

The primary side controller 7 can determine the instant when the ADC samples Vₒ. This allows sampling of a settled output. The start of the received data package on the secondary side triggers the ADC sampling process.

The secondary side uses the encoded data to adjust a programmable reference voltage to produce the selected Vₒ.

Both sides can send auxiliary data to the opposite side. This data is appended to the main data. This auxiliary data may include safety signals like over-voltage-protection (OVP), over-temperature-protection (OTP) and power failure (PF) but also arbitrary end-user data.

The following summarises some features and benefits:
Effect of optocoupler aging on analog transmission of data is avoided.
Support of bi-directional transmission of digital data across the isolation barrier through external optical or capacitive isolation barrier components.
Minimum number of isolation barrier components: Only two optocouplers are required to handle multiple signals. No extra channels are required for clock information. In order to accommodate the transmission of additional information from the secondary side to the primary side, such as over voltage protection (OVP) and over temperature protection (OTP), the traditional analog approach requires an additional optocoupler for each signal transmitted.
A broken primary-secondary link will be detected.
Minimised bit-rate through optimized data packets/frames. Low bit-rate will reduce the cost of barrier components. Barrier components will transmit digital information only. Barrier component deterioration will not affect SMPC dynamic performance.
Primary digital SMPC controller fully controls sampling time instant of the analog to digital converter.
Primary side digital SMPC controller can transmit up to 16 arbitrary digital signals to the secondary side.

The communication modules 5 and 6 allow the bi-directional data link between the primary and secondary side of the SMPS, and they consist of:
Interfaces to external modules, i.e. DSP, Vref, ADC and auxiliary signals.
Serial Data receiver and transmitter circuits.
Clock recovery circuit on secondary side.

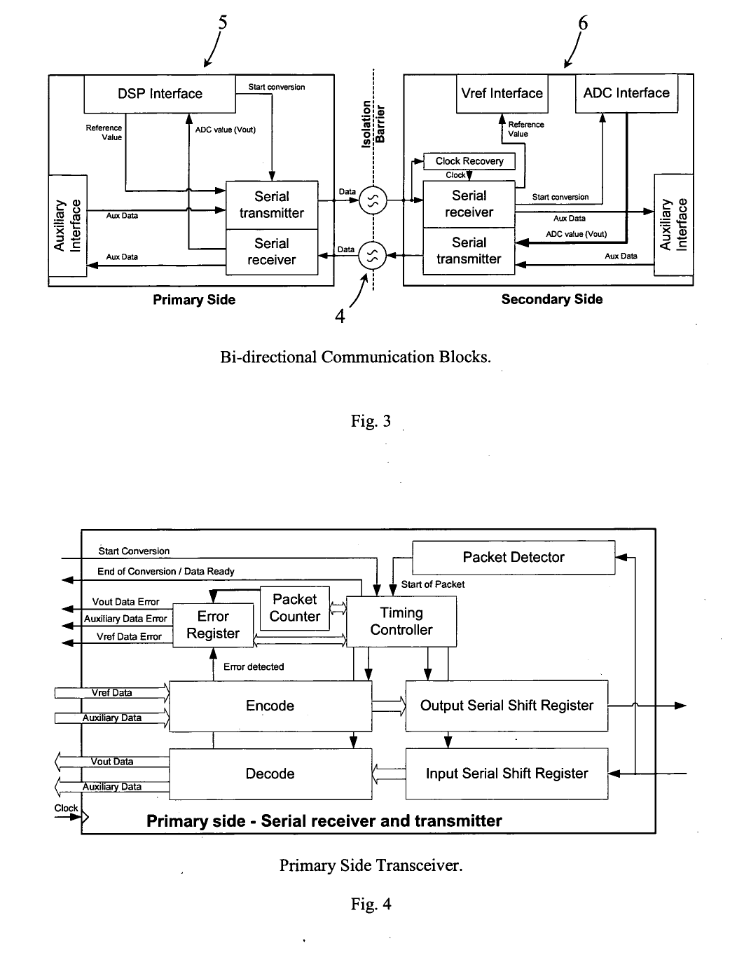

These are shown in more detail in FIG. 3, and the interface modules shown in FIG. 3 have the following functions:
Register incoming and outgoing signals.
Synchronisation of incoming asynchronous signals (AUX Interface only).
Ensure proper I/O timing, e.g. reading the ADC result back when it is valid.
Serial-to-Parallel and Parallel-to-Serial conversion.

The transceiver modules contain the data transmitter and receiver. These are implemented by serial shift registers and en-/decoders and contain additional sub-modules for timing and error handling. Both Primary-to-Secondary and Secondary-to-Primary transceivers are shown in FIG. 4 and FIG. 5. They are implemented using similar circuitry but differ significantly in number and direction of interface signals.

The primary side transceiver is clocked by the primary side clock. The secondary side has to recover this clock from the incoming data and provide this clock to the secondary side transceiver. This is shown in FIG. 5. The outgoing secondary-to-primary packages are sent synchronously to the primary side clock. This allows the primary side receiver to sample secondary data without need for synchronisation.

Description of Blocks
Output Shift Register Serial shift register. Performs Parallel to Serial Conversion. Shifting and loading is controlled by the timing controller.
Input Shift Register Serial shift register. Performs Serial to Parallel Conversions. Shifting is controlled by the timing controller.
Encoder Encodes data signals into the form needed for transmission. Forward error correction bits are added for data integrity.
Decoder Decodes data back to original form and corrects/detects errors using the forward error correction bits.
Packet Detector Detect the start of a new incoming data packet.
Timing Controller Central logic which controls the timing of all other modules. This can be implemented as a state machine or as combinational logic.
Packet Counter Stores current packet number.
Error Register Stores reported data errors and indicates which data (Vout, Vref, Aux) is in error.
Clock recovery Recovers the clock signal from the incoming data. This can be implemented either as state machine or as digital phase-locked loop.

Data Packages

The data packages sent contain the following information in encoded form together with forward error correction and protocol bits.

Primary-to-Secondary Side Package
Sampling time instant i.e. controls when ADC samples the output voltage Vₒᵤₜ (see information below).
Digital representation of the reference voltage value V_{ref}, which determines the nominal output voltage.
Package number, to synchronise package frames on both sides.
Auxiliary data signals (e.g. “power loss detected”).

Secondary-to-Primary Side Package
ADC value, i.e. output voltage Vₒᵤₜ.
Auxiliary data signals (e.g. “over voltage detected”, “over temperature detected”).

Encoding of Sampling Instant.

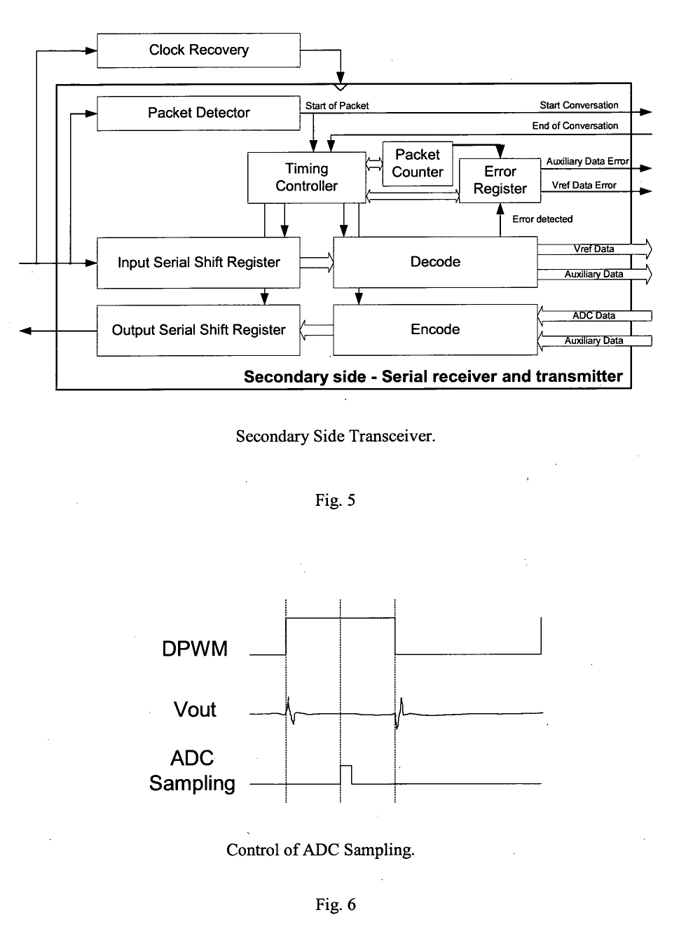

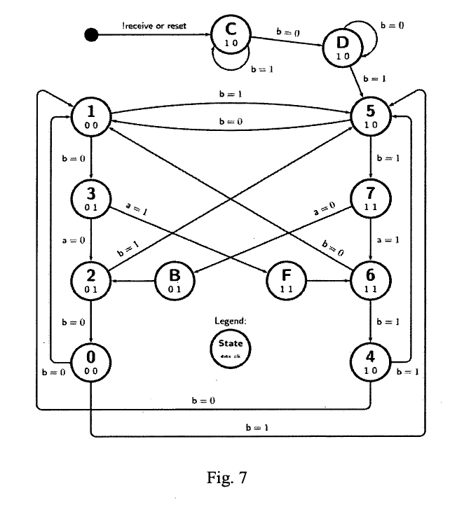

Control of the sampling instant of the ADC is very important for digitally controlled SMPCs. The primary side loop controller contains a DPWM which produces a signal that controls the primary side switches (FIG. 6). The rising and falling edges of this signal cause the switches to turn ON/OFF. This produces a transient disturbance on the secondary side output V₀. The ADC sampling instant should be controlled to avoid sampling during a transient disturbance. The optimal sampling instant occurs midway between the rise and fall of the DPWM signal. This information is known a priori by the primary side loop controller. An advantageous aspect is transmission of this information from the primary side to the secondary side to allow optimal positioning of the ADC sampling instant.

The ADC sample timing information cannot be encoded within the data packets as digital data. The transmission latency to receive and decode a digital value representing the ADC sample time information is too long for cycle-by-cycle control of the ADC sampling time on the secondary side. The ADC sampling time instant is determined by receipt of the primary-to-secondary data package on the secondary side. The sequence of operations is:
The primary side transmitter sends a new primary-to-secondary package when instructed to by the primary side loop controller.
The receipt of a new package on the secondary side is determined by the packet detector (FIG. 4).
The packet detector recognises a new packet by the presence of a packet start code.
The packet detector immediately outputs a signal to trigger the ADC sampling.

This scheme allows the ADC sample instant to be adjusted individually for each switching phase of the power converter. The loop controller preferentially sets the sample time instant to be during the positive duty cycle of the primary side switches. Also, because the packets contain redundant information, their length can be adjusted without destroying critical primary-to-secondary data.

The latency between transmitter and receiver is mostly due to the coupler latency with some smaller delays for the triggering and detection. The loop controller can compensate this latency by advancing timing of the data packet.

Package Frames and Package Numbers

While the main information, Vₒᵤₜ, is sent in full with each package. The additional, less time critical information, i.e. V_{ref} and the auxiliary signals, is only sent bit-wise with each package. This reduces the package length and allows for higher speeds.

All packages containing bits for the same data value compose a package frame. Each primary-to-secondary package contains a package number that is zero at begin of every frame and gets continuously incremented with every package. The secondary side can synchronise itself to this package number to ensure the correct order and alignment of all information bits. Because the secondary-to-primary side packages are direct responses to the primary-to-secondary they don't need to include an own package number.

Prototype Board

A prototype board has been developed which includes the full SMPS, the ADC with programmable reference voltage and the data coupler. The digital communication modules are implemented on Field Programmable Gate Array (FPGA) development boards, which are connected to the prototype board.

Clock Synchronization

A master clock operates at a multiple N of the nominal primary side clock. A state machine has a number of states 2N+2 intermediate states and 2 start-up states. Each state is represented by 2 bits, containing a bit (a) which is the received serial data bit and a bit (b) which is the secondary side Master clock. The machine moves between states directed by a change in either (a) or (b). While the state machine remains in states 0−N the recovered clock is nominally zero. While the machine is in states N−2N−1 the state is 1.

In more detail, and referring to FIG. 7 the primary and secondary communication sides do not share a common clock. In order to synchronize the incoming primary data the secondary side contains a clock synchronizer which extracts the primary side clock from the data stream and outputs both the recovered clock and the synchronized data. The falling edge of the recovered clock is then used to send the secondary data back to the primary side. Because this clock is held synchronous to the primary side clock the primary side can simply read the incoming data stream without the need of further synchronization.

The secondary side clock synchronizer is implemented as follows:
A master clock which operates at four times the nominal primary side clock is used to clock the clock synchronizer.
A state machine is used which has five states (0-3, B) for the low (0) and five states (4-6, F) for the high level (1) of the input data.
The input to the state machine is the input data stream, which is read at the rising and falling edge of the master clock.
For every input bit with the nominal bit period time the state machine is through four of the associated states either 0-3 (if input bit is zero) or 4-6 (if input bit is one).
Maintaining Synchronisation between primary and secondary is achieved by:
   A slower-then-nominal primary side clock is compensated by using a fifth state (F or B) i.e. extending the bit length by 25% for the current input bit.
   A faster-then-nominal primary side clock is compensated by skipping the fourth state (0 or 4), i.e. shortening the bit length by 25% for the current input bit.
The outputs of the state machine are the recovered clock and data signals which are defined only by the state encoding of the current state, as shown in the figure below.
Two initialization states (C and D) are used after reset to ensure proper start.

The invention is not limited to the embodiments described but may be varied in construction and detail.

1-24. (canceled)

25. A digital power converter comprising:
a primary power stage,
a secondary power stage,
primary side circuits including a loop controller,
secondary side circuits including an ADC,
a communications interface between the primary and secondary sides, and
wherein each of the primary and secondary side circuits include a transmitter and a receiver for bi-directional communication of data across the interface.

26. The digital power converter as claimed in claim 25, wherein the secondary side circuits comprise means for using encoded data from the primary side to adjust a reference voltage.

27. The digital power converter as claimed in claim 25, wherein the primary side circuits and the secondary side circuits comprise means for sending auxiliary data to the other of said primary side circuits and secondary side circuits.

28. The digital power converter as claimed in claim 25, wherein the primary side circuits and the secondary side circuits comprise means for sending auxiliary data signals to the other of said primary side circuits and secondary side circuits, said auxiliary data signals including over-voltage protection safety signals.

29. The digital power converter as claimed in claim 25, wherein the primary side circuits and the secondary side circuits comprise means for sending auxiliary data to the other of said primary side circuits and secondary side circuits, said auxiliary data signals including over-temperature protection signals.

30. The digital power converter as claimed in claim 25, wherein the primary side circuits and the secondary side circuits comprise means for sending auxiliary data signals to the other of said primary side circuits and secondary side circuits, said auxiliary data signals including power failure signals.

31. The digital power converter as claimed in claim 25, wherein the primary side circuits and the secondary side circuits comprise means for sending auxiliary data to the other of said primary side circuits and secondary side circuits, wherein the auxiliary signals include user data.

32. The digital power converter as claimed in claim 25, wherein the transmitters and receivers are adapted to register incoming and outgoing signals, and to synchronise incoming asynchronous signals.

33. The digital power converter as claimed in claim 25, wherein the transmitters and receivers are adapted to ensure correct input/output timing such as reading an ADC result back.

34. The digital power converter as claimed in claim 25, wherein at least one transmitter comprises a shift register for data transfer across the interface.

35. The digital power converter as claimed in claim 25, wherein the transmitter and receiver are combined as a transceiver on at least one side.

36. The digital power converter as claimed in claim 25, wherein the primary side loop controller is adapted to adjust the sample time instant of the secondary side ADC.

37. The digital power converter as claimed in claim 25, wherein the secondary side circuits are adapted to receive an encoded data packet and to use it as an ADC sample trigger.

38. The digital power converter as claimed in claim 25, wherein the interface comprises two couplers for bi-directional communication

39. The digital power converter as claimed in claim 25, wherein the interface comprises at least one opto-coupler.

40. The digital power converter as claimed in claim 25, wherein the primary side circuits are adapted to generate data packages and to send them across the interface to the secondary side circuits.

41. The digital power converter as claimed in claim 25, wherein the primary side circuits are adapted to generate data packages and to send them across the interface to the secondary side circuits; and wherein said data packages generated by the primary side circuits include a digital representation of a nominal output voltage.

42. The digital power converter as claimed in claim 25, wherein the primary side circuits are adapted to generate data packages and to send them across the interface to the secondary side circuits; and wherein said packages generated by the primary side circuits include a package number for synchronisation of packages on both sides.

43. The digital power converter as claimed in claim 25, wherein the primary side circuits are adapted to generate data packages and to send them across the interface to the secondary side circuits; and wherein said primary side circuits are adapted to transmit to the secondary side circuits packages containing a package number and successive packages for a frame have a number which is incremented, and the secondary side circuits are adapted to synchronise to the package numbers to ensure the correct order and alignment of information bits, and the secondary side circuits are adapted to transmit to the primary side circuits packages which are direct responses to received packages.

44. The digital power converter as claimed in claim 25, wherein the primary side circuits are adapted to generate data packages and to send them across the interface to the secondary side circuits; and wherein said packages generated by the secondary side circuits include an ADC value indicating output voltage and auxiliary data signals.

45. The digital power converter as claimed in claim 25, wherein the primary side circuits are adapted to generate data packages and to send them across the interface to the secondary side circuits; and wherein said primary side circuits are adapted to transmit to the secondary side circuits packages containing a package number and successive packages for a frame have a number which is incremented, and the secondary side circuits are adapted to synchronise to the package numbers to ensure the correct order and alignment of information bits, and the secondary side circuits are adapted to transmit to the primary side circuits packages which are direct responses to received packages; and wherein the secondary side circuits comprise a clock synchronizer for extracting the primary side clock from a data stream and outputting both a recovered clock and synchronized data and for using a falling edge of the recovered clock is to send secondary side data back to the primary side and the primary side circuits are adapted to read an incoming data stream without the need of further synchronization because the clock is held synchronous to the primary side clock.

46. The digital power converter as claimed in claim 25, wherein the primary side circuits are adapted to generate data packages and to send them across the interface to the secondary side circuits; and wherein said primary side circuits are adapted to transmit to the secondary side circuits packages containing a package number and successive packages for a frame have a number which is incremented, and the secondary side circuits are adapted to synchronise to the package numbers to ensure the correct order and alignment of information bits, and the secondary side circuits are adapted to transmit to the primary side circuits packages which are direct responses to received packages; and wherein the secondary side circuits comprise a clock synchronizer for extracting the primary side clock from a data stream and outputting both a recovered clock and synchronized data and for using a falling edge of the recovered clock is to send secondary side data back to the primary side and the primary side circuits are adapted to read an incoming data stream without the need of further synchronization because the clock is held synchronous to the primary side clock; and wherein the secondary side circuits are adapted to transmit data packages to the primary side circuits in synchronism with said clock.

47. The digital power converter as claimed in claim 25, wherein the primary side circuits are adapted to generate data packages and to send them across the interface to the secondary side circuits; and wherein said primary side circuits are adapted to transmit to the secondary side circuits packages containing a package number and successive packages for a frame have a number which is incremented, and the secondary side circuits are adapted to synchronise to the package numbers to ensure the correct order and alignment of information bits, and the secondary side circuits are adapted to transmit to the primary side circuits packages which are direct responses to received packages; and wherein the secondary side circuits comprise a clock synchronizer for extracting the primary side clock from a data stream and outputting both a recovered clock and synchronized data and for using a falling edge of the recovered clock is to send secondary side data back to the primary side and the primary side circuits are adapted to read an incoming data stream without the need of further synchronization because the clock is held synchronous to the primary side clock; and wherein said clock synchronizer comprises a master clock which operates at a multiple N of a nominal primary side clock, and a state machine which has a number 2N+2 of intermediate states and 2 start-up states; wherein each state is represented by a received serial data bit and a bit which is the secondary side master clock; and the state machine moves between states directed by a change in either of said bits and while the state machine remains in states 0−N the recovered clock is nominally zero, and while the machine is in states N−2N−1 the state is 1.

48. The digital power converter as claimed in claim 25, wherein the loop controller comprises a digital pulse width modulator adapted to provide a signal that controls the primary side switches, in which rising and falling edges of this signal cause the switches to turn ON/OFF, causing a transient disturbance on the secondary side output; and the loop controller is adapted to transmit a signal to the ADC to cause the sampling instant to occur midway between the rise and fall of the DPWM signal, to allow optimal positioning of the ADC sampling instant.

49. The digital power converter as claimed in claim 25, wherein the loop controller is adapted to compensate for latency in communication between the primary side circuits and the secondary side circuits by advancing timing of a data packet transmission.
